(19) United States
(12) Patent Application Publication
(10) Pub. No.: US 2023/0269860 A1
(43) Pub. Date: Aug. 24, 2023

(54) HIGH ELECTRON TRAPPING RATIO BETATRON

(71) Applicant: Leidos Engineering, LLC, Walled Lake, MI (US)

(72) Inventors: Gongyin CHEN, Oceanside, CA (US); J. Stephen BAUMGART, Vista, CA (US); Gregory GREENWOOD, Vista, CA (US); James SHEA, San Diego, CA (US)

(73) Assignee: Leidos Engineering, LLC, Walled Lake, MI (US)

(21) Appl. No.: 17/676,348

(22) Filed: Feb. 21, 2022

(51) Int. Cl. H05H 11/02; H05H 7/04

(52) U.S. Cl. CPC H05H 11/02; H05H 7/04

(57) ABSTRACT

Aspects of the present disclosure provide a betatron for accelerating electrons. For example, the betatron can include magnet core parts spaced apart by an air gap. At least one main coil can be arranged on the magnet core parts. A betatron tube can be arranged in the air gap for electrons to circulate therein. A control circuit can be electrically coupled to the main coil. The control circuit can be configured to control a main coil current flowing through the main coil, such that as the control circuit increases the main coil current during a current ramp up period, the control circuit maintains the main coil current at a constant level during an injection period when the electrons are injected into the betatron. The current ramp up period can include a short pause and the injection period.

### FIELD OF THE PRESENT DISCLOSURE

The present disclosure relates generally to betatrons for accelerating electrons.

### BACKGROUND

Betatron has been used to accelerate electrons and to produce high energy x-rays. It uses synchronized magnetic field and magnetic flux (usually produced by the same coil or coils) to accelerate electrons in a circular electron orbit. Increasing magnetic flux inside the electron orbit accelerates orbiting electrons while increasing and synchronized magnetic field confines electrons at/near the orbit. Electrons are pre-accelerated by an electron gun and injected into the circular orbit when magnetic field and flux are still low, and when magnetic field at the orbit is appropriate for confining electrons near the orbit with electrons at injection energy. Betatron has been around for about a century and so has its basic architecture and the major bottleneck to performance—low electron trapping ratio during electron injection. Since main coil current rises during injection, in existing betatrons matching condition between magnetic field and electron injection energy (and between magnetic flux and electron injection energy) for trapping electrons is hard to find and does not last. Modern electronics has made it possible to hold main coil current constant, providing constant magnetic field near betatron orbit during injection, to improve electron trapping.

### SUMMARY

Aspects of the present disclosure provide a betatron for accelerating electrons. For example, the betatron can include magnet core parts spaced apart by an air gap in the magnet core, which will be called air gap for the remainder of the text. At least one main flux and field coil, which will be called the main coil for the reminder of the text, can be arranged on the magnet core parts. A betatron tube can be arranged in the air gap for electrons to circulate therein. A control circuit can be electrically coupled to the main coil. The control circuit can be configured to control a main coil current flowing through the main coil, such that as the control circuit increases the main coil current during an acceleration period, the control circuit maintains the main coil current at a constant level during an injection period when the electrons are injected into the betatron. After electron injection, the control circuit allows the main coil current to resume increase, accelerating orbiting electrons to designed energy.

For example, the control circuit can include a main storage capacitor, a first switch A, a second switch B and a third switch C. The first switch A has a current limiting resistor in series. The main storage capacitor is charged to appropriate voltage before an acceleration cycle (charging circuit is not shown in the drawings). The first switch A and the third switch C conduct from the beginning of an acceleration cycle, allowing the main storage capacitor to increase the main coil current. The second switch B does not conduct until electron injection is complete. Current flowing through the first switch A will increase to a value limited by the current limiting resistor (The same current flows through the third switch C and the main coil since the second switch B does not conduct at this time). Main coil current (equaling current flowing through the first switch A and the third switch C at this time) is held constant and electron injection is performed. The second switch B conducts after electron injection, i.e., after the injection period at time t1d of the drawings. This allows the current flowing through the main coil and the third switch C to resume increase. When the main coil current reaches designed value (electrons reaching designed energy), expansion is performed to produce x-rays.

The first switch can include an integrated gate bipolar transistor (IGBT). In further embodiments, the betatron can further include adjustment to the constant main coil current value for electron injection. This allows magnetic field at electron orbit at time of injection to match injection energy for optimal electron trapping at a given electron injection energy. This is achieved by adjusting the gate control signal level of the first switch A or the reference voltage of an operational amplifier that includes an output coupled to the first switch A. In an embodiment, the betatron can further include a second switch in parallel with the first switch and the current limiting resistor, the second switch configured to allow the main coil current, which is kept by the current limiting resistor, to resume increase after electron injection. In another embodiment, the betatron can further include a conducting circuit coupled to the second switch, the conducting circuit configured to control the second switch to conduct after electron injection is complete. For example, the conducting circuit can be an operational amplifier that has two inputs to receive a reference voltage and the control voltage, respectively, and an output coupled to the second switch.

In another embodiment, the first switch and the current limiting resistor can be coupled in series with the main coil at one end, and the betatron can further include a third switch coupled in series with the main coil at the other end, the third switch configured to conduct the main coil current flowing through the main coil.

In an embodiment, the first switch and the current limiting resistor can be coupled in series with the main coil at one end, and the betatron can further include a storage capacitor coupled in series with the main coil at the other end, the storage capacitor configured to provide the main coil current.

In further embodiments, the betatron can further include an electron source electrically coupled to the control circuit, the electron source configured to inject the electrons into the betatron tube when main coil current, and therefore magnetic field, is held constant. For example, the electron source can include a thermionic electron gun, which is also commonly called a diode electron gun. As another example, the electron source can include a gridded gun, which is also commonly called a triode electron gun. In an embodiment, the electron source can be applied with a constant injection voltage when injecting the electrons into the betatron tube.

In an embodiment, the betatron can further include an expansion coil arranged between the magnet core parts and the betatron tube and electrically coupled to the control circuit, the expansion coil configured to receive an expansion current pulse such that the electrons circulating in the betatron tube have electron energy boosted, and as a result the electrons with energy boosted by the expansion coil can no longer be confined by the magnetic field at orbit and expand outward. In another embodiment, the betatron can further include an x-ray target for the electrons with the boosted electron energy to hit to produce x-ray radiation. For example, the x-ray target can have a corrugated configuration.

Aspects of the present disclosure provide a method for accelerating electrons using a betatron. The betatron can include magnet core parts spaced apart by an air gap, at least one main coil arranged on the magnet core parts, and a betatron tube arranged in the air gap for electrons to circulate therein. For example, the method can include increasing a main coil current flowing through the main coil during an acceleration period, and maintaining the main coil current at a constant level during an injection period when the electrons are injected into the betatron tube.

In an embodiment, the injection period can be included within the main coil current increase period. In another embodiment, the main coil current can be increased nonlinearly during the acceleration period.

This summary section does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1a is a magnet block diagram of an existing betatron;

FIG. 1B is a top view of a portion of the betatron shown in FIG. 1a;

FIG. 2a is an overall timing diagram illustrating the operation of the betatron shown in FIGS. 1a and 1b;

FIG. 2b is an enlarged view of a portion, represented by the dashed ellipse, of the timing diagram of FIG. 2a;

FIG. 2c is an enlarged view of a portion, represented by the dashed circle, of the timing diagram of FIG. 2a;

FIG. 3 is a magnet block diagram of an exemplary betatron in accordance with some embodiments of the present disclosure;

FIG. 4a is an overall timing diagram illustrating the operation of the exemplary betatron in accordance with some embodiments of the present disclosure;

FIG. 4b is an enlarged view of a portion, represented by the dashed ellipse, of the timing diagram of FIG. 4a;

FIG. 4c is an enlarged view of a portion, represented by the dashed circle, of the timing diagram of FIG. 4a;

FIG. 5 is a circuit diagram of an exemplary control circuit that can keep constant a main coil current of a main coil of the exemplary betatron during an injection period, in accordance with some embodiments of the present disclosure;

FIG. 6 shows a circuit diagram of another exemplary control circuit that can keep the main coil current constant during the injection period, in accordance with some embodiments of the present disclosure;

FIG. 7 shows a circuit diagram of yet another exemplary control circuit that can keep the main coil current constant during the injection period, in accordance with some embodiments of the present disclosure;

FIG. 8a shows a diode electron gun in accordance with some embodiments of the present disclosure;

FIG. 8b shows a triode electron gun in accordance with some embodiments of the present disclosure;

FIG. 9a shows a commonly used x-ray target; and

FIG. 9b shows an exemplary x-ray target that has a corrugated configuration in accordance with some embodiments of the present disclosure.

### DETAILED DESCRIPTION

Betatron uses synchronized magnetic field and magnetic flux (usually produced by the same coil or coils) to accelerate electrons in a circular electron orbit. The magnetic pole piece is shaped so that the betatron field condition and betatron stability condition are satisfied. Betatron field condition requires that vertical magnetic field B_{y} at nominal orbit is half the average inside nominal orbit:

$${B}_{y} ( r = {R}_{0} ) = \frac{1}{2} * Φ / ( π {R}_{0}^{2} ) .$$

Betatron stability condition requires that magnetic field gradient (B_{y} vs. r) to be

$${B}_{y} ( r ) ∼ \frac{1}{{r}^{n}} , 0 < n < 1 ,$$

with empirical best value of n=0.6. Such gradient and associated radial field component Bᵣ provide transverse stability (radial and vertical). Increasing magnetic flux inside the electron orbit accelerates orbiting electrons, while synchronized and increasing magnetic field confines electrons at/near the orbit. Electrons are pre-accelerated by an electron gun and injected into the circular orbit when magnetic field and flux are still low—and when the magnetic field at the electron orbit is appropriate to confine electrons at injection energy near the electron orbit. Relatively low injection energy combined with changing magnetic field during injection leads to low electron trapping ratio, the fraction of injected electrons that end up orbiting and being accelerated. The mitigation in large betatrons is increasing injection energy. Compact betatrons have found wide spread use in non-destructive testing (NDT) and in security inspection. Due to its small size, injection energy is practically limited to about 40 keV. Techniques, such as “contraction,” can be used to modify the magnetic field near the electron orbit during electron injection period and to help the electrons to move in after being injected from outside of the main orbit, improving the trapping ratio. Various factors make injection pulse shape unstable, further reducing the trapping ratio and its stability. State of the art electron trapping ratio in compact betatrons is on the order of 0.1%. Such a low trapping ratio can limit the performance of the betatrons.

According to some aspects of the present disclosure, a betatron having electron trapping ratio improved can be provided. For example, the betatron can utilize constant magnetic field and constant injection energy, by keeping a main coil current and an injection voltage constant during an electron injection period, to improve the electron trapping ratio. Optimal main coil current (and therefore magnetic field) at time of injection at a given injection energy is determined experimentally

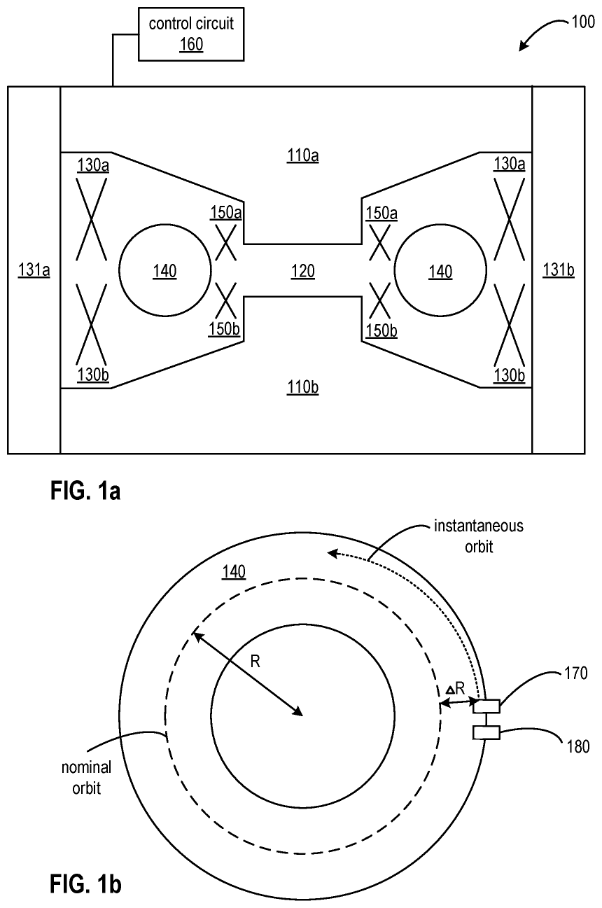

FIG. 1a is a magnet block diagram of an existing betatron 100. FIG. 1B is a top view of a portion of the betatron 100. The betatron 100 can include a magnet core of two parts (or referred to as magnet core parts) 110a and 110b that are spaced apart by an air gap 120. The shape of the magnet core parts 110a and 110b can be selected by a person having ordinary skill in the art (PHOSITA) depending on the application. For example, the surfaces of the magnet core parts 110a and 110b facing each other can be sloped to satisfy the betatron field condition and betatron stability condition. The air gap 120 between the magnetic core parts 110a and 110b is usually made to be adjustable to fine tune system to satisfy betatron field condition and betatron stability condition. It can be an air gap or a space that is formed from a non-magnetic material having a melting temperature in excess of the operating temperature of the betatron 100, e.g., 150° C. For example, the material can include polytetrafluoroethylene and similar polymers.

One or more main field/flux coils 130a and 130b (represented by the large “X,” hereinafter referred to as “main coils” for brevity) can be arranged on (e.g., wound around) shoulders or necks of the magnet core parts 110a and 110b, respectively. The magnetic flux produced by the main coils 130a and 130b loops through the magnet core parts 110a and 110b and return yokes 131a and 131b, and runs across the air gap 120, including the air gap space that a betatron tube 140 occupies.

The betatron tube 140 can be arranged in the air gap 120, and, as such, some of the magnetic flux produced by the main coils 130a and 130b can be diverted toward the betatron tube 140. The betatron tube 140 can be an evacuated, toroid-shaped (e.g., donut-shaped), low thermal expansion ceramic or glass tube, in which electrons can be circulated and accelerated. For example, the betatron tube 140 can be evacuated to 10⁻⁸ to 10⁻⁹ mm (e.g., 5×10⁻⁹ mm) of Hg or less, to minimize electron loss from collisions with residual gas molecules. In an embodiment, the interior surface of the betatron tube 140 can be coated with a suitable resistive coating, which, when grounded, can prevent excessive surface charge buildup, which has a detrimental effect on the circulating electrons. In another embodiment, a vacuum getter can be placed inside the betatron tube 140, for the purpose of completing and maintaining the vacuum.

An electron source 170 can be arranged at a radius outside (e.g., a radius R+ΔR as shown in FIG. 1B) or inside (e.g., a radius R-ΔR) a nominal (or main) orbit (which has a radius R) of the betatron tube 140. In an embodiment, the electron source 170 can include a thermionic electron gun (or called a diode gun), which is enclosed inside the betatron tube 140 and located at the outer edge of the toroidal space of the betatron tube 140, and can inject electrons into the betatron tube 140. For example, the cathode of electron source 170 can be biased to a negative injection high voltage and pulsed on for a few microseconds (e.g., ˜3 μs) at the time when the injected electrons will travel on an instantaneous orbit defined by its instantaneous energy and instantaneous local magnetic field. The instantaneous orbit is of the radius R+/−ΔR when the electrons are just injected into the betatron tube 140. The betatron field condition is not satisfied on this instantaneous orbit. R+/−ΔR, depending on local magnetic field—recall the magnetic field has a radial gradient. Moreover, the instantaneous orbit is also offset from the nominal orbit—the instantaneous turning center is not the center of the betatron tube 140—because electrons are injected from the outer edge. Electrons travel outside of the nominal orbit when they loop back close to the electron source 170, and travel inside of the nominal orbit when they loop to the opposite side (half turn from the electron source 170). Average instantaneous turning radius is near main orbit radius but electron track has an offset from the main orbit. The location of injection, or the location of the electron source 170, is not on the main orbit. The orbit offset reduces as electrons orbit more circles, with or without increasing main coil current. The difference between average radius (ΔR) and nominal orbit radius shrinks with increasing electron energy and increasing magnetic field as main coil current increases.

An x-ray target 180 can be arranged inside the betatron tube 140 and at the outer edge of vacuum enclosure of the betatron tube 140. At the end of an acceleration period of an acceleration cycle, when a main coil current flowing through the main coils 130a and 130b almost arrives at desired value, one or more expansion coils (represented by the small “x”) 150b provide an addition boost of magnetic flux inside the electron orbit 140 (and therefore electron energy) without increasing magnetic field at the main orbit and the electrons circulating and accelerating in the betatron tube 140 can expand onto the x-ray target 180 to produce x-ray radiation (or x-ray production) or other high-energy phenomena. The spectrum of the x-ray radiation can depend on the final energy of the electrons and the material of the x-ray target.

One or more contraction coils (represented by the small “x”) 150a and the expansion coils (represented by the small “x”) 150b can be arranged between the front sides of the magnet core parts 110a and 110b and the betatron tube 140, respectively. The radius of the contraction coils 150a and the expansion coils 150b is smaller than the radius R of the nominal orbit of the electrons in the betatron tube 140. The precise size and positioning of the contraction coils 150a and the expansion coils 150b can be selected by PHOSITA depending on the application.

A control circuit 160 can be electrically connected to the main coils 130a and 130b, the contraction coils 150a and the expansion coils 150b for supplying time-varying current pulses at a repetition rate to the main coils 130a and 130b, the contraction coils 150a to help improving electron trapping during an electron injection period of the acceleration cycle and the expansion coils 150b to expand electrons reaching desired energy to the x-ray target 180, producing x-ray radiation.

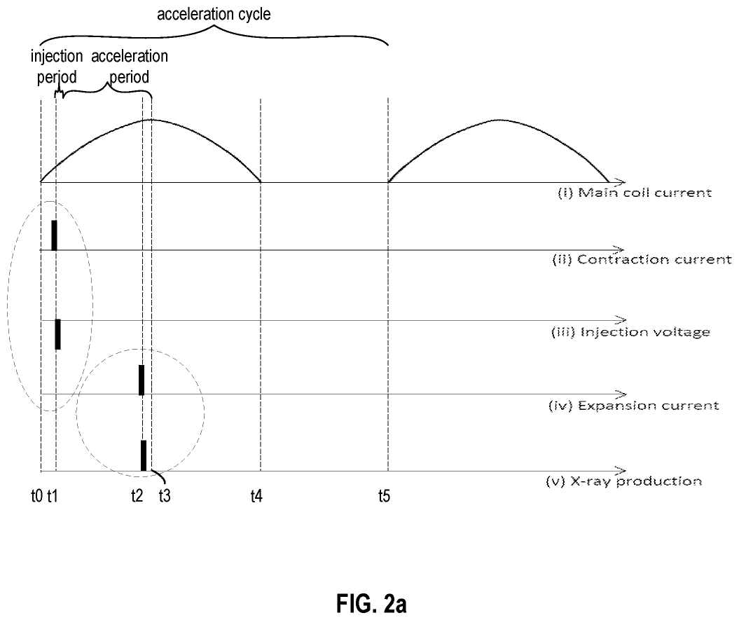

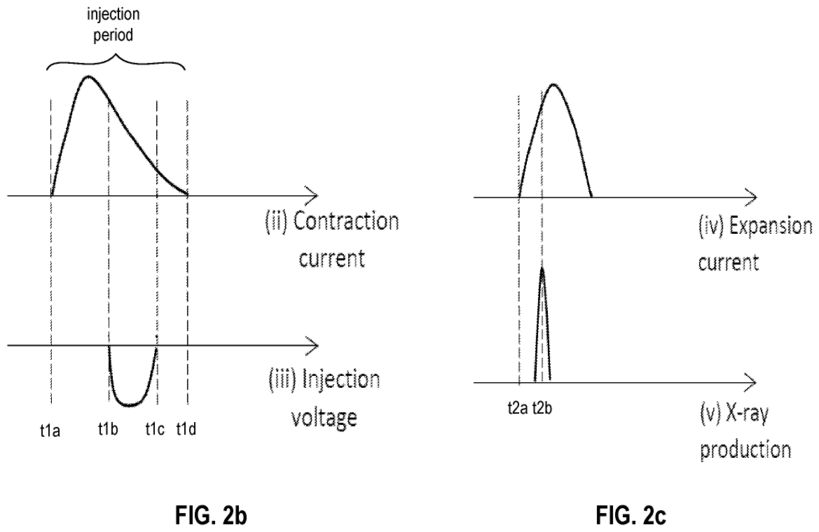

FIG. 2a is an overall timing diagram illustrating the operation of the betatron 100. At time to, the control circuit 160 can start a new acceleration cycle. For example, a storage capacitor (not shown) of the control circuit 160 can be pre-charged by a power supply (e.g., a high voltage DC power supply), and the pre-charged storage capacitor can ramp up the main coil current in the main coils 130a and 130b and the magnetic flux in the betatron tube 140 continuously. Magnetic field at the orbit and magnetic flux inside the orbit increase proportionally. Increasing magnetic flux produces an induced electromotive force

$$( emf ) ( = \frac{e}{2 π R} \frac{d Φ}{dt} )$$

that gives the electrons additional energy and increases the electron momentum. Increasing magnetic field produces the increasing radial force

$$( i . e . , Lorentz force evB = \frac{{mv}^{2}}{R} )$$

whose direction is perpendicular to the electron velocity which keeps the electrons moving in circular path (e.g., along the instantaneous orbit) and is balanced by a centripetal force. As a result, the electrons can be accelerated and forced into the nominal orbit within the betatron tube 140. Thus, the electron acceleration occurs only with increasing magnetic flux.

Around time t1, the main coil current, and therefore the magnetic field at the orbit, reaches a value that is approximately suitable for designed electron injection energy, and the contraction coils 150 can receive a brief contraction current pulse. As the electrons are injected into the betatron tube 140 from the outer edge of vacuum space of the betatron tube 140, they have varying instantaneous turning radius and the trajectory is offset from the geometric center of the betatron tube 140. The orbit offset reduces as electrons orbit more circles, with or without increasing main coil current. Electrons are also accelerated since the main coil current keeps increasing. The difference between average radius (ΔR) and nominal orbit radius shrinks with increasing electron energy and increasing magnetic field as main coil current increases. The contraction current pulse briefly disturbs the proportion relation between magnetic field at the orbit and magnetic flux inside the orbit. Experimentally adjusting contraction and injection timing enables the electrons to move to the nominal orbit more quickly. For example, the “contraction” can help the electrons to move in and improve electron trapping compared with the increasing main coil current alone.

Then (at time t1), the injection period starts, and electrons can be injected by the electron source 170 into the betatron tube 140. For example, the electron source 170 can be biased to a negative injection high voltage and pulsed on for a few microseconds at the time when the injected electrons will travel on the instantaneous orbit in the rising magnetic flux produced by the main coils 130a and 130b. As the magnetic flux increases, orbit offset reduces, and the instantaneous orbit moves closer to the nominal orbit of the betatron tube 140. The acceleration period follows the injection period. While the injected electrons circulate in the betatron tube 140 during the acceleration period, their electron energy increases, and some of the electrons will be trapped to circulate near the nominal orbit of the betatron tube 140. In a compact betatron example, the main coil current is of approximately 6.5 amps at time of electron injection and approximately 300 amps when the electrons reach 9 MeV energy. The electrons can be injected at around 40 keV, at 0.5 to 1.5 amps injection current which lasts for ˜3 μs, for example. Since the main coil current increases during injection, matching condition between the magnetic flux and the injection energy is hard to find and does not last, resulting in very low electron trapping ratio. Contraction somewhat improves electron trapping to approximately 0.1% in existing compact betatrons.

Around time t2, the main coil current reaches a value that corresponds to desired electron energy. The expansion coil 150b can receive a brief expansion current pulse and the electron energy gets a boost. Magnetic field is insufficient to contain circulating electrons to the orbit and the electrons expand out to hit the x-ray target 180, producing x-ray radiation.

At time t3, the acceleration period ends, and the electrons with their electron energy boosted have expanded to the outer edge of the betatron tube 140 to hit the x-ray target 180, producing x-ray radiation. Shortly after the x-ray production, the control circuit 160 can terminate the main coil current increase. The main coil current decreases as it is directed to charge back the storage capacitor.

At time t4, the main coil current reduces to zero and the storage capacitor has recouped most of the cycling energy. Top up charging is usually required, by a power supply, for example, to compensate energy dissipation.

At time t5, the control circuit 160 can start a new acceleration cycle.

FIG. 2b is an enlarged view of a portion (represented by the dashed ellipse) of the timing diagram of FIG. 2a. FIG. 2b shows the injection timing details of the injection period. At time t1a, the contraction current pulse starts and goes into the contraction coil 150a. The pulse shape can be determined by the pre-charged contraction storage capacitor value and the contraction coil inductance value, and may not be actively controlled by a timing circuit. The injection voltage is applied to the electron source 170 at time t1b and ends at time t1c. Some of the injected electrons will be trapped and circulate near the nominal orbit of the betatron tube 140. At time t1d, the contraction current pulse and the injection voltage are both over, and the trapped electrons continue to be accelerated by the main coils 130a and 130b induced flux increase. Optimal timing of time t1a and t1b can be determined experimentally.

FIG. 2c is an enlarged view of another portion (represented by the dashed circle) of the timing diagram of FIG. 2a. FIG. 2c shows the expansion timing details. At time t2a, the expansion current pulse starts and goes into the expansion coil 150b. The pulse shape can be determined by the pre-charged expansion storage capacitor value and the expansion coil inductance value, and may not be actively controlled by the timing circuit. Electron energy gets a boost in addition to acceleration by the main coils 130a and 130b induced flux increase. The magnetic field is not sufficient to contain the electrons at the nominal orbit so they expand to the outer edge of the betatron tube 140. Around time t2b, the electrons hit the x-ray target 180 to produce x-rays radiation. Adjusting time t2a affects final electron energy. For example, earlier time t2a corresponds to lower electron energy, while later time t2a correspond to higher electron energy.

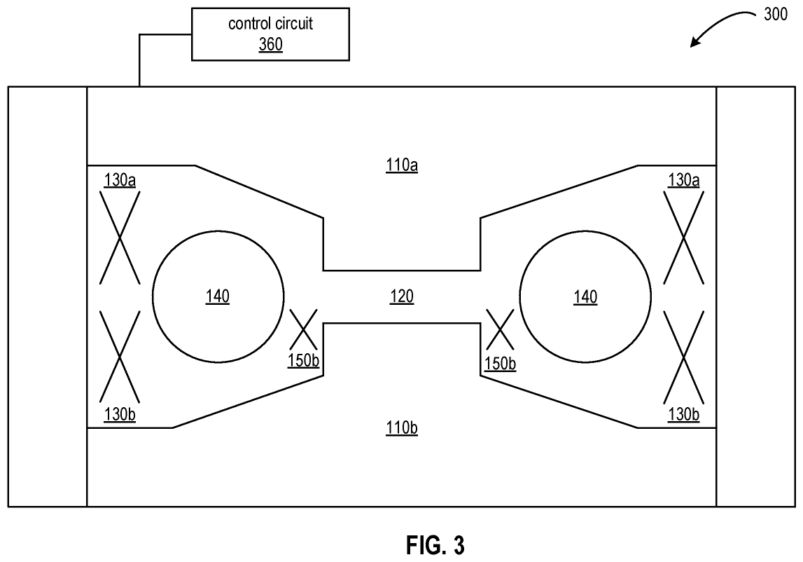

FIG. 3 is a magnet block diagram of an exemplary betatron 300 in accordance with some embodiments of the present disclosure. The exemplary betatron 300 can include a compact betatron. The exemplary betatron 300 can be similar to the exemplary betatron 100. For example, the exemplary betatron 300 can also include the magnet core parts 110a and 110b, the main coils 130a and 130b arranged on the shoulders of the magnet core parts 110a and 110b, respectively, the betatron tube 140 arranged in the air gap 120, by which the magnet core parts 110a and 110b are spaced apart, the expansion coil 150b arranged inside the main orbit, the electron source 170, and the x-ray target 180. The air gap 120 between the magnetic core parts 110a and 110b is usually made to be adjustable to fine tune system to satisfy betatron field condition and betatron stability condition. The exemplary betatron 300 can further include a control circuit 360 that is electrically connected to the main coils 130a and 130b and the expansion coils 150b for supplying time-varying current pulses at a repetition rate to the main coils 130a and 130b, and the expansion coils 150b to expand electrons reaching desired energy to the x-ray target 180, producing x-ray radiation. In an embodiment, the magnetic field induced by the main coils 110a and 110b and the injection energy (or injection voltage) provided by the electron source 170 can be kept constant during an injection period, during which the electrons are injected into the betatron tube 140. The electron source 170 can be configured to inject electrons into the betatron tube 140 when the main coil current, and therefore the magnetic field, is kept constant. The main coil current (and hence the magnetic field) can be experimentally determined by adjusting the actual current value for a given injection energy. The injection energy is preferably at a value as high as allowed by practical betatron tube.

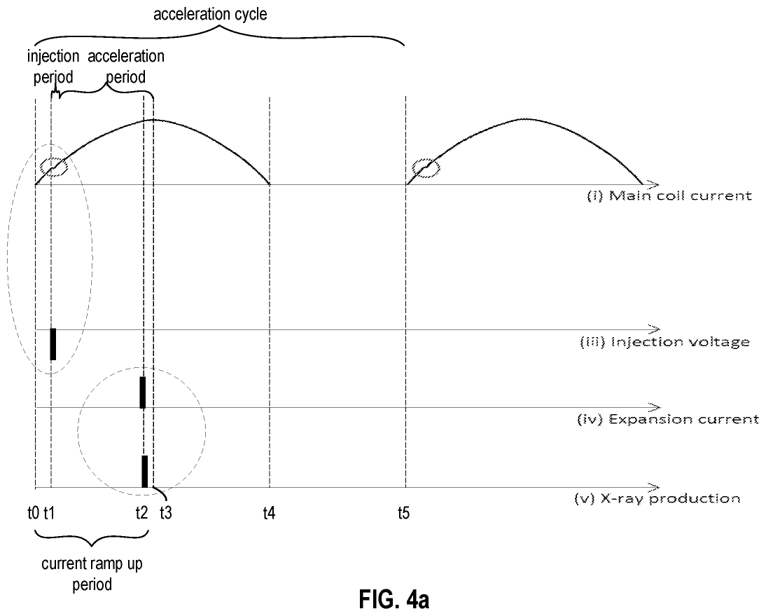

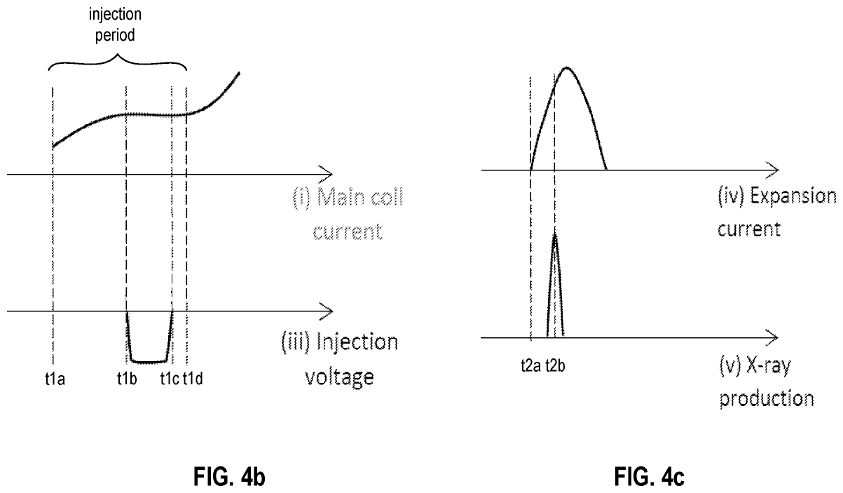

FIG. 4a is an overall timing diagram illustrating the operation of the exemplary betatron 300 in accordance with some embodiments of the present disclosure. At time t0, the control circuit 360 can start a new acceleration cycle. For example, a storage capacitor (not shown) of the control circuit 360 can be pre-charged, and the pre-charged storage capacitor can ramp up the main coil current in the main coils 130a and 130b, pause briefly for electron injection, and resume ramping up current till electrons are accelerated to desired energy. In an embodiment, the main coil current can be increased nonlinearly.

At time t1, the main coil current reaches a value that is appropriate for designed electron injection energy, and the injection period starts. The control circuit 360 holds the main coil current constant for electrons injection. During the injection period, electrons can be injected by the electron source 170, which is located at the outer edge of vacuum enclosure, into the betatron tube 140. For example, the electron source 170 can be biased to a negative injection high voltage and pulsed on for a few microseconds (e.g., −3 μs) at the time when the injected electrons will travel on an instantaneous orbit at constant magnetic field maintained by the main coil current, which is held constant for injection. Electron energy stays constant for the injection period in which the main coil current is held constant. The acceleration period follows the injection period. Orbit offset reduces and circulating electrons move close to the nominal orbit. In an embodiment, the main coil current can be approximately 6.5 A for injection. Since the main coil current (and therefore magnetic field) is held constant during injection, the value it's held can be adjusted to match injection energy for optimal electron trapping. After electron injection, the control circuit 360 allows the main coil current to resume its increase, accelerating trapped electrons near the nominal orbit.

Around time t2, the main coil current almost arrives at the designed value for desired electron energy. Then (at time t2) the expansion coil 130b can receive a brief expansion current pulse and the electron energy gets a boost from the expansion current pulse but the magnetic field does not. Betatron field condition is thus violated and the electron orbit will expand (hence “expansion”), and the electrons hit the x-ray target 180, producing x-ray radiation. In an embodiment, the period from time t0 to time t2 can be referred to as a current ramp up period, and the injection period can be included within the current ramp up period.

At time t3, shortly after the x-ray production the acceleration period ends, and the control circuit 360 can terminate the main coil current increase. The main coil current decreases as it is directed to charge back the storage capacitor. (this portion of the control circuit 360 is not shown)

At time t4, the main coil current reduces to zero and the storage capacitor has recouped most of the cycling energy. Charge losses of the storage capacitor can be replenished by a power supply, for example, to compensate energy dissipation (not shown).

At time t5, the control circuit 360 can start a new acceleration cycle.

FIG. 4b is an enlarged view of a portion (represented by the dashed ellipse) of the timing diagram of FIG. 4a. FIG. 4b shows the injection timing details of the injection period. At time t1a, the control circuit 360 controls the main coil current to approach a value appropriate for electron injection as pre-determined injection energy and be kept constant during the injection period. The constant value of the main coil current during the injection period for a given injection energy can be adjusted by the control circuit 360 for optimal electron trapping. The injection voltage is applied to the electron source 170 at time t1b and ends at time t1c, during which the main coil current is kept constant, and can be kept constant during the injection period. At time t1d, after electron injection, the control circuit 360 controls the main coil current to resume its increase accelerating trapped electrons near the nominal orbit. The constant main current value can be experimentally determined for designed injection energy. Since the magnetic field and the injection energy are both held constant during the injection period, matching condition becomes easier to find and lasts for the duration of injection.

FIG. 4c is an enlarged view of another portion (represented by the dashed circle) of the timing diagram of FIG. 4a. FIG. 4c shows the expansion timing details. At time t2a, electron nears designed energy, the expansion current pulse starts and goes into the expansion coil 150b, and the electron energy gets a boost in addition to acceleration by the main coils 130a and 130b induced flux increase. The magnetic field at the orbit is not sufficient to contain the electrons at the nominal orbit so they move outward inside the betatron tube 140. Around time t2b, the electrons hit the x-ray target 180 to produce x-rays radiation.

As the main coil current of the main coils 130a and 130b of the betatron 300 is kept constant during the injection period, higher electron trapping ratio is achieved and much lower injection current from the electron source 170 would be needed. This brings a lot of benefits. Higher electron trapping ratio requires a lower injection current, which means reduced cathode heating power consumed by the electron source 170, reduced stress on the resistive coating of the betatron tube 140, and reduced stress on vacuum getter used in the betatron tube 140—longer life time. Higher electron trapping ratio leads to a lower injection current, which increases electron source impedance which eases pulse generator burden and reduces instability. Higher electron trapping ratio requires a lower injection charge density, which reduces space charge effect (loss of electrons already circulating to ongoing electron injection). The contraction coil 150a, which is included in the betatron 100, is not needed in the betatron 300, which means few components and less heat (e.g., ˜100 watts) generated.

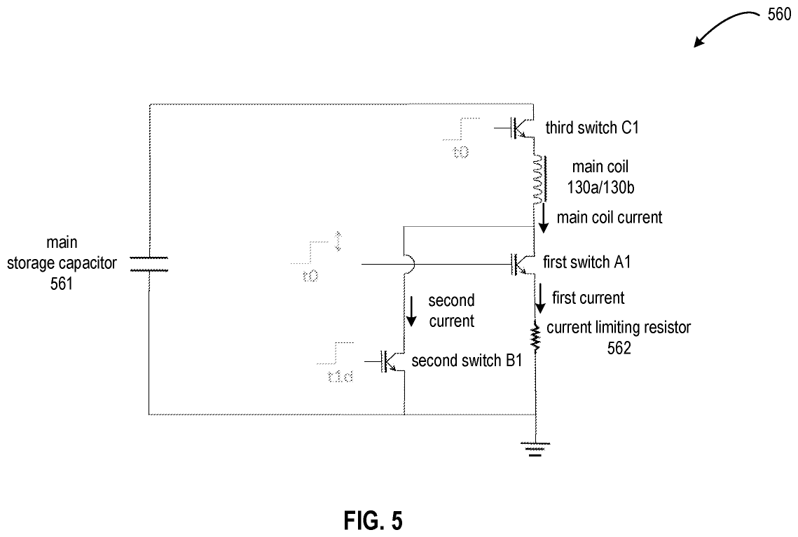

FIG. 5 is a circuit diagram of an exemplary control circuit 560 that can keep the main coil current of the main coils 130a and 130b constant during the injection period, in accordance with some embodiments of the present disclosure. For example, the control circuit 560 can be the control circuit 360. In an embodiment, the control circuit 560 can include a main storage capacitor 561. The main storage capacitor 561 can be coupled to a power supply (not shown) for providing the main coil current. For example, the main storage capacitor 561 can be charged to an appropriate voltage before an acceleration cycle.

A first switch A1 is electrically connected in series with the main coils 130a and 130b and can conduct a first current flowing from the main storage capacitor 561 through the main coils 130a and 130b from start of each acceleration cycle (e.g., from time t0 shown in the timing diagram of FIG. 4a), allowing the main storage capacitor 561 to increase the first current. For example, the first switch A can include an integrated gate bipolar transistor (IGBT).

A current limiting resistor 562 can be electrically connected in series with the first switch A1, and limit the first current flowing through the first switch A1 to a constant value (e.g., after time t1b shown in the timing diagram of FIG. 4b), which allows the magnetic field at the electron orbit at time of electron injection to match the injection energy for optimal electron trapping at a given electron injection energy. The constant value can be adjusted by a control voltage applied to the gate of the first switch A1 (e.g., a first IGBT A1). For example, adjusting the control voltage applied to the gate of the first IGBT A1 can change a desired constant value of the first current during the injection period. In an embodiment, the current limiting resistor 562 can be of a value of 1 ohm, which would leads to −40 W of instantaneous power and less than 1 W of average power (consumed by the current limiting resistor 562).

A second switch B1 can be electrically connected in parallel with the first switch A1 and the current limiting resistor 562 and electrically connected in series with the main coils 130a and 130b. The second switch B1 does not conduct any current until after the injection period (e.g., after time t1d shown in the timing diagram of FIG. 4b). After the injection period, the second switch B1 can conduct a second current, allowing the main coil current, which equals the first current during the injection period, which is kept constant by the current limiting resistor 562 during the injection period, to resume its increase. For example, the second switch B1 can include an IGBT.

A third switch C1 can conduct the main coil current during the acceleration cycle, and does not conduct any current after time t4 shown in the timing diagram of FIG. 4a. The current (i.e., the main coil current) through the third switch C1 equals a sum of the first current flowing through the first switch A1 and the second current flowing through the switch B1, and is the total current flowing in the main coils 130a and 130b.

It should be noted that the control circuit 560 shown here is only a portion of electronics that drives the main coils 130a and 130b. Once the acceleration period finishes and electrons are “expanded” to make x-ray radiation, another set of switches would direct the main coil current to charge the main storage capacitor 561, which usually works in unipolar in modern compact Betatrons. Also, there is some energy dissipation in each cycle (eddy current in iron core, ohm heating in coil, loss to switches and the vacuum tube, and energy picked up by electrons, etc.), so, necessarily, the main storage capacitor 561 can be topped up to compensate for the loss, e.g., by a power supply.

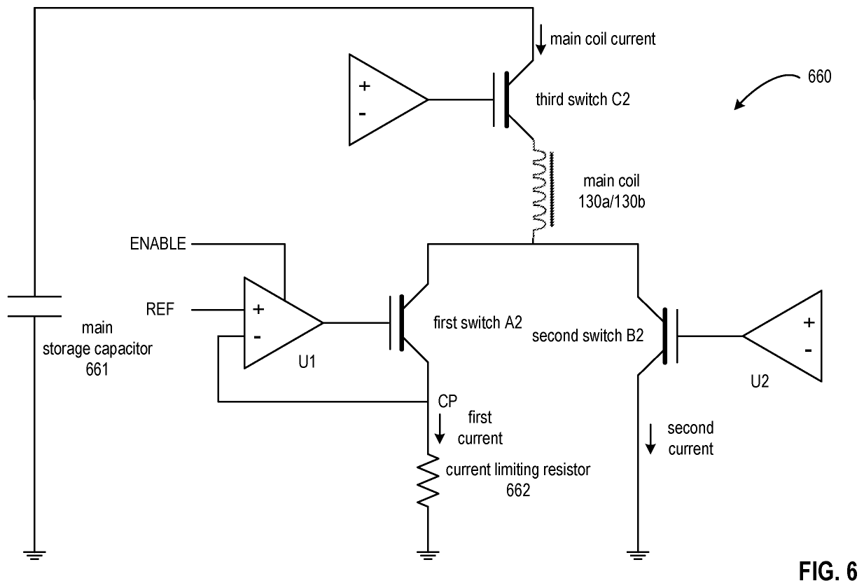

FIG. 6 shows a circuit diagram of an exemplary control circuit 660 that can keep the main coil current of the main coils 130a and 130b constant during the injection period, in accordance with some embodiments of the present disclosure. For example, the control circuit 660 can be the control circuit 360. In an embodiment, the control circuit 660 can include a main storage capacitor 661. The main storage capacitor 661 can be coupled to a power supply (not shown) for providing the main coil current. For example, the main storage capacitor 661 can be charged to an appropriate voltage before an acceleration cycle.

A first conducting circuit U1 is electrically connected in series with the main coils 130a and 130b, and can control a first switch A2 to conduct a first current from start of each acceleration cycle (e.g., from time t0 shown in the timing diagram of FIG. 4a). For example, the first conducting circuit U1 can include an operational amplifier. A current limiting resistor 662 can be electrically connected in series with the first switch A2, and limit the first current flowing through the first switch A2 to a constant value (e.g., after time t1b shown in the timing diagram of FIG. 4b). The constant value can be adjusted by a reference voltage REF to a non-inverting input of the first conducting circuit U1. Adjusting the reference voltage REF can change a desired constant value of the first current of the first switch A2 during the injection period. Accordingly, the first conducting circuit U1 can control the first switch A2 to conduct the first current to flow through the first switch A2 based on a control voltage at a connection point CP of the first switch A2 with the current limiting resistor 662. Voltage across the current limiting resistor 662 is used for feedback control, removing instability of the switch.

A second switch B2 is electrically connected in parallel with the first switch A2 and the current limiting resistor 662 and electrically connected in series with the main coils 130a and 130b. A second conducting circuit U2 can control the second switch B2 not to conduct any current until after the injection period (e.g., after time t1d shown in the timing diagram of FIG. 4a). For example, the second conducting circuit U2 can include an operational amplifier. After the injection period, the second conducting circuit U2 can control the second switch B2 to conduct the second current, allowing the main coil current, which equals the first current during the injection period, which is kept constant by the current limiting resistor 662 during the injection period, to resume increase.

A third switch C2 can conduct the main coil current during the acceleration cycle, and does not conduct any current after time t4 shown in the timing diagram of FIG. 4a. The current (i.e., the main coil current) through the third switch C2 equals the first current flowing through the first switch A2 and the second current flowing through the second switch B2, and is the total current flowing in the main coils 130a and 130b.

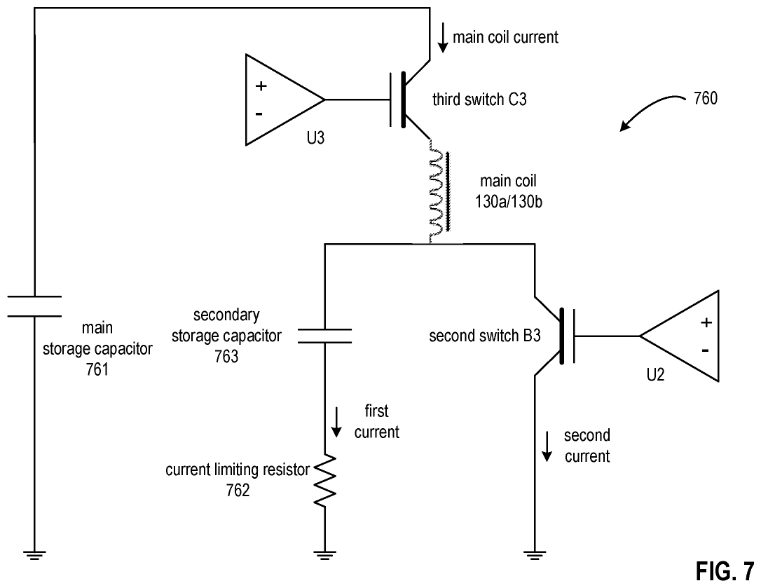

FIG. 7 shows a circuit diagram of an exemplary control circuit 760 that can keep the main coil current of the main coils 130a and 130b constant during the injection period, in accordance with some embodiments of the present disclosure. The control circuit 760 can be the control circuit 360. In an embodiment, the control circuit 760 can include a main storage capacitor 761. The main storage capacitor 761 can be coupled to a power supply (not shown) for providing the main coil current. For example, the main storage capacitor 761 can be charged to an appropriate voltage before an acceleration cycle.

A third switch C3 is electrically connected in series with the main coils 130a and 130b, and can be controlled by a third conducting unit U3 to turn on first at time t0 (i.e., the start of the acceleration cycle). A second switch B3 is electrically connected in series with the main coils 130a and 130b, and can be controlled by a second conducting unit U2 to turn on at time t1d (i.e., the end of the injection period). A secondary storage capacitor 763 and a current limiting resistor 762 are electrically connected in series with each other and with the main coils 130a and 130b, and are electrically connected in parallel with the second switch B3. With 0 charge on the secondary storage capacitor 763, the current limiting resistor 762 can limits the charge rate of the secondary storage capacitor 763 and hence the main coil current in the main coils 130a and 130b. As the secondary storage capacitor 763 charges, the voltage across the current limiting resistor 762 decreases which reduces a first current in the secondary storage capacitor 763 and hence the main coils 130a and 130b. If the turn-on time between the second switch B3 and the third switch C3 is small, the decline in the main coil current in the main coils 130a and 130b will be minimal and will appear as a near constant current. The differences between the control circuit 560 in FIG. 5 and the control circuit 760 in FIG. 7 are the initial current ramp and the number of switches. In FIG. 5 the initial current ramps more slowly where the initial current ramp of the control circuit 760 in FIG. 7 ramps similar to only the main coils 130a and 130b present and slowly decreases as the secondary storage capacitor 763 charges. The current (i.e., the main coil current) through the third switch C3 equals a sum of a second current flowing through the second switch B3 and the first current flowing through the current limiting resistor 762 and the secondary storage capacitor 763, and is the total current flowing in the main coils 130a and 130b.

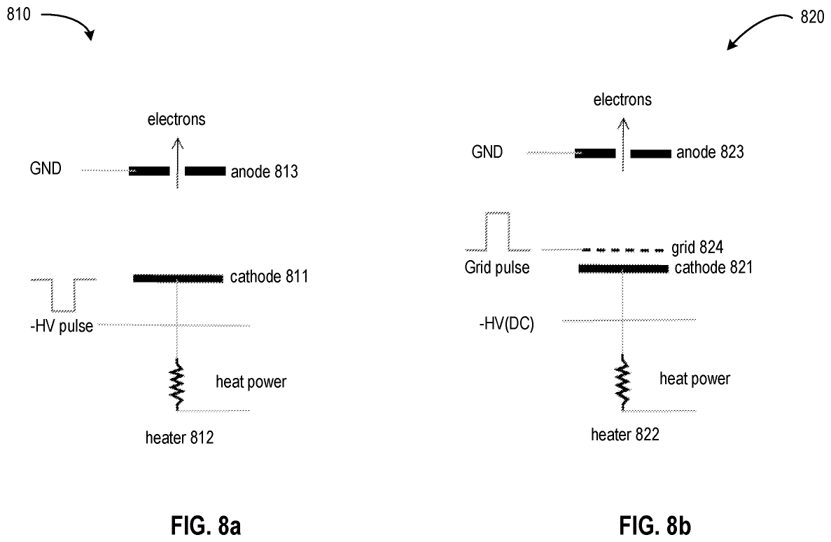

FIG. 8a shows a diode electron gun 810 in accordance with some embodiments of the present disclosure. The diode electron gun 810 can be used as the electron source 170 to inject electrons into the betatron tube 140 of the exemplary betatron 300. The diode electron gun 810 can include a cathode 811, a heater (or a filament) 812, and an anode 813. The heater 812 can be connected to the cathode 811 and receive heat power to heat the cathode 811. The cathode 811, after being heated by the heater 812, can emit electrons under applied electric field. For example, the cathode 811 can be coupled to a negative pulse voltage (typically on the order of tens of kilovolts (kV), such as −40 kV) to pull out electrons from the cathode surface and accelerate them to corresponding energy (e.g., at 40 keV). The anode 813 can be held at or near ground to form an electric field between the cathode 811 and the anode 813, which can focus and accelerate the electron stream away from the cathode 811.

FIG. 8b shows a triode electron gun (also called a gridded electron gun) 820 in accordance with some embodiments of the present disclosure. The triode electron gun 820 can be used as the electron source 170 to inject electrons into the betatron tube 140 of the exemplary betatron 300. The triode electron gun 820 can include a cathode 821, a heater (or a filament) 822, an anode 823, and a grid (or a control grid) 824. The heater 822 can be connected to the cathode 821 and receive heat power to heat the cathode 821. The cathode 821, after being heated by the heater 822, can create a stream of electrons under applied electric field. The cathode 821 can be coupled to a negative fixed (e.g., DC) voltage (typically on the order of tens of kilovolts (kV), such as −40 kV) to repel the created electrons of corresponding energy (e.g., at 40 keV). The grid 824 can be an electrode disposed between the cathode 821 and the anode 823 (e.g., disposed just above the cathode 821) in a vacuum enclosure that functions as a “gate” to control the stream of electrons reaching the anode 823. For example, a more negative voltage pulse (e.g., a grid pulse) on the grid 824 will repel the electrons created by the cathode 821 back toward the cathode 821 so fewer electrons get through to the anode 823. As another example, a less negative, or positive, voltage pulse on the grid 824 will allow more electrons to reach the anode 823. Since the negative cathode voltage is DC, energy of injected electrons can be more stable at a designed value. Therefore, the triode electron gun 820 can allow more control and flexibility over the energy and timing of a voltage pulse through the use of the grid 824 than the diode electron gun 810. The grid 824 can be normally held at a third potential, typically within around 100 V below the cathode 821 to prevent electron emission. A positive grid pulse, usually on the order of tens of volts to hundreds of volts, enables electron injection. The anode 823 can be held at or near ground to form an electric field between the cathode 821 and the anode 823, which can focus and accelerate the electron stream away from the cathode 821.

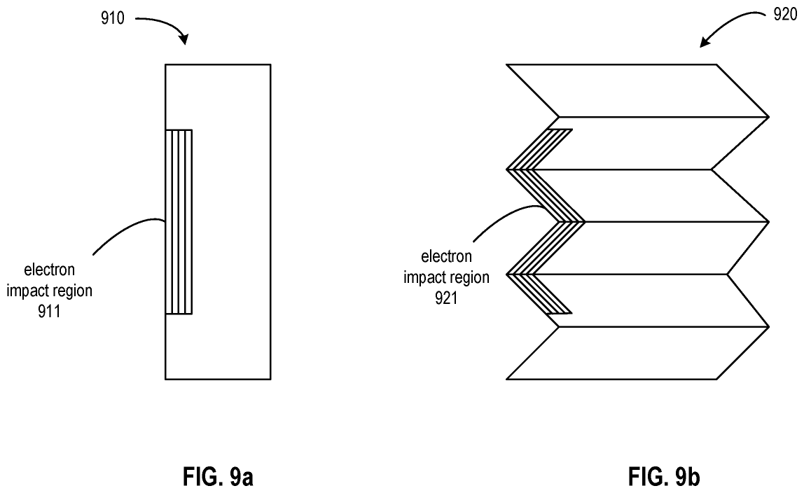

FIG. 9a shows an x-ray target 910. In compact betatrons, the x-ray target 910 can be placed inside a vacuum enclosure and it removes heat primarily by emission. Materials with high emissivity and high melting temperature, such as tantalum, are preferred.

FIG. 9b shows an exemplary x-ray target 920 in accordance with some embodiments of the present disclosure. The exemplary x-ray target 920 can be used as the x-ray target 180. The exemplary x-ray target 920 can have a corrugated configuration, and thus have an electron impact area 921 larger than an electron impact area 911 of the x-ray target 910. The x-ray target 920 also has a larger electron impact volume, allowing peak heating per pulse to spread over more material. As electrons hit the target in each cycle, the heat target receives is not transferred away and will cause a temperature spike within the impact volume, potentially melting or evaporating target material in the impact region. Between x-ray pulses, heat spreads from impact area and is emitted out. Since emission power is proportional to surface area, the corrugated configuration of the x-ray target 920, which has a large surface area, can increase target heat removal capability and therefore achieves higher does output.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

“Substrate” or “target substrate” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a layer on or overlying a base substrate structure such as a thin film. Thus, substrate is not limited to any particular base structure, underlying layer or overlying layer, patterned or un-patterned, but rather, is contemplated to include any such layer or base structure, and any combination of layers and/or base structures. The description may reference particular types of substrates, but this is for illustrative purposes only.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. A betatron for accelerating electrons during an acceleration cycle, comprising:
magnet core parts spaced apart by an air gap;
at least one main coil arranged on the magnet core parts;
a betatron tube arranged in the air gap for electrons to circulate therein; and
a control circuit electrically coupled to the main coil, the control circuit configured to control a main coil current flowing through the main coil, such that as the control circuit increases the main coil current during a current ramp up period of the acceleration cycle, the control circuit maintains the main coil current at a constant level during an injection period of the acceleration cycle when the electrons are injected into the betatron.

2. The betatron of claim 1, wherein the control circuit includes:
a main storage capacitor coupled in series with the main coil, the main storage capacitor configured to be charged to a voltage before the acceleration cycle;
a first switch coupled in series with the main coil and the main storage capacitor, the first switch configured to conduct during the acceleration cycle;
a current limiting resistor coupled in series with the first switch and the main storage capacitor, the current limiting resistor configured to keep constant a first current flowing through the first switch; and
a second switch coupled in parallel with the first switch and the current limiting resistor and coupled in series with the main coil and the main storage capacitor, the second switch configured to conduct a second current after the injection period,
wherein the main coil current equals a sum of the first current and the second current.

3. The betatron of claim 2, further comprising a conducting circuit coupled to the first switch and the current limiting resistor, the conducting circuit configured to control the first switch to conduct the second current based on a control voltage at a connection point of the first switch with the current limiting resistor.

4. The betatron of claim 3, wherein the conducting circuit includes an operational amplifier having two inputs to receive a reference voltage and the control voltage, respectively, and an output coupled to the first switch.

5. The betatron of claim 4, wherein the first switch includes an integrated gate bipolar transistor (IGBT) that has a gate coupled to the output of the conducting circuit, adjusting the reference voltage changing the first current.

6. The betatron of claim 2, further comprising a third switch coupled in series with the main coil and the main storage capacitor, the third switch configured to conduct the main coil current flowing through the main coil during the acceleration cycle.

7. The betatron of claim 1, wherein the control circuit includes:
a main storage capacitor coupled in series with the main coil, the storage capacitor configured to be charged to a voltage before the acceleration cycle;
a secondary storage capacitor coupled in series with the main coil;
a current limiting resistor coupled in series with the secondary storage capacitor and the main coil, the current limiting resistor configured to limit a charge rate of the secondary storage capacitor and a first current flowing through the current limiting resistor; and
a second switch coupled in series with the main coil and coupled in parallel with the secondary storage capacitor and the current limiting resistor, the second switch configured to conduct a second current after the injection period,
wherein the main coil current equals a sum of the first current and the second current.

8. The betatron of claim 1, wherein the injection period is included within the current ramp up period.

9. The betatron of claim 1, further comprising an electron source electrically coupled to the control circuit, the control circuit configured to control the electron source to inject the electrons into the betatron tube during the injection period.

10. The betatron of claim 9, wherein the electron source includes a thermionic electron gun.

11. The betatron of claim 9, wherein the electron source includes a triode electron gun.

12. The betatron of claim 9, wherein the electron source is applied with a constant injection voltage when injecting the electrons into the betatron tube.

13. The betatron of claim 1, further comprising an expansion coil arranged between the magnet core parts and the betatron tube and electrically coupled to the control circuit, the expansion coil configured to receive an expansion current pulse such that the electrons circulating in the betatron tube have electron energy boosted.

14. The betatron of claim 13, further comprising an x-ray target for the electrons with the electron energy boosted to hit to produce x-ray radiation.

15. The betatron of claim 14, wherein the x-ray target has a corrugated configuration.

16. A method for accelerating electrons during an acceleration cycle using a betatron that includes magnet core parts spaced apart by a core gap, at least one main coil arranged on the magnet core parts, and a betatron tube arranged in the core gap for electrons to circulate therein, the method comprising:
increasing a main coil current flowing through the main coil during a current ramp up period of the acceleration cycle; and
maintaining the main coil current at a constant level during an injection period of the acceleration cycle when the electrons are injected into the betatron tube.

17. The method of claim 16, wherein the injection period is included within the current ramp up period.

18. The method of claim 16, wherein the main coil current is increased nonlinearly during the current ramp up period.

19. An x-ray target for electrons accelerated by a betatron to hit to produce x-ray radiation, the x-ray target having a corrugated configuration.

20. The x-ray target of claim 19 being made of tantalum.
